(19) United States
(12) Patent Application Publication
(10) Pub. No.: US 2004/0133815 A1
(43) Pub. Date: Jul. 8, 2004

(54) Data processing method and device with state-restoring function

(76) Inventor: Kang-Chung Cheng, Taipei (TW)

Correspondence Address: Han-Yi Lee, BAYSHORE PATENT GROUP, LLC., 520 Chantecler Dr., Fremont, CA, 94539, US

(21) Appl. No.: 10/677,036

(22) Filed: Sep. 30, 2003

(30) Foreign Application Priority Data
Jan. 8, 2003 (TW) 092100368

(51) Int. Cl. G06F 1/30

(52) U.S. Cl. 713/300

(57) ABSTRACT

A data processing method with a state-restoring function in which a data-processing device is in an initial state before supplying of a main power source; the device activates BIOS when the power source supplies, and discriminates whether a store device is stored therein environmental parameters before power interruption, if no, the operating system is activated to enter an operating mode. When the power source is interrupted, the data-processing device uses a spare power source to execute a waiting procedure, if now the main power source is resumed, the data-processing device immediately restores the operating mode. If the main power source has not yet been resumed at the end of the waiting procedure, the data-processing device stores the environmental parameters in the store device and reboots. Then the data-processing device continuously discriminates whether supplying of the main power source has been resumed until the restoration. If the main power source is resumed, the data-processing device automatically enters the booting process, and restores the state before interruption using the environmental parameters to update the operation environment of the data-processing device.

### FIELD OF THE INVENTION

The present invention is related to a data processing method, and especially to a data processing method with a state-restoring function.

### BACKGROUND OF THE INVENTION

Since prosperous development of the information industry, people have relied on computers more and more from day to day, and have required more and more the stability of computer systems. Among the multiple factors that influence the stability of computers, an important one is power source. In order to avoid interruption of a power source to induce data missing or damage, people generally will add additionally a spare power supply as a spare power source for a computer system, when the main power source (such as a city power supply) is interrupted, the spare power supply can be used to take the place of the power supplying work of the main power source, so that the computer system can keep on operating for a period of time during losing the main power.

In computer systems, the most often seen spare power supply are Uninterruptible Power Supply (UPS). A UPS is expensive, if a user only needs that a spare power source is used before shutdown to save the unsaved data in a short time (e.g., 15 to 20 seconds) when a power source is interrupted, the UPS evidently is too much valuable. In the words, the user pays a high price for a simple requirement; this is unworthy.

And more, conventionally, the data processing method for abnormal interruption of a power source is to use a spare power source to maintain operation of the system; then a shutdown process is taken to turn off the computer before exhaustion of the spare power source (or after the set shutdown time of the spare power source is up). Such measure has a large defect, i.e., the system will be unable to automatically boot the computer by lacking the mechanism of discrimination about whether a main power source restores when the system is being shut down while the main power source is resumed. Therefore at this time, although the main power source has been resumed for power supplying, the system will still be forced to shut down. Under the environment of a server, restarting of a computer needs a professional to execute; if each time it must have an MIS staff to deal with a booting process when a power source is interrupted, this will be an extraordinary burden of work for the MIS staff who is busy enough. Even if the system is restarted smoothly, the truth is that the operation environment has only gotten back to the initial state after entering into the operating system rather than to the state before the power source is interrupted though; thereby, the user shall try hard to activate sequentially every application program and related file to get connection with the work before the power source is interrupted.

Taking a simple example for explanation, a computer class has a server in managing operations of several decades of personal computers; the server and all the computers will automatically shut down when a power source is interrupted. When the main power source restores, it must have a professional to perform the cumbersome booting process of the server in the first place, then students can do their work to restore the computers back to the states before the power source is interrupted; this is very inconvenient.

### SUMMARY OF THE INVENTION

In view of the above stated, the object of the present invention is to provide a data processing method with a state-restoring function, after resumption of electric power, the present invention can automatically restore the state of working before the power source is interrupted.

To get the above stated object of the present invention, a data processing method with a state-restoring function is provided, the method suits a data-processing device having a spare power source; wherein the data-processing device is mounted with a store device. When the data-processing device is in the state of shutdown, it is a data-processing device in the initial state. The method comprises the following steps: 1. an electric-power restoring step of a main power source: a. the data-processing device discriminates whether power supplying of the main power source is normal; if yes, a step (b.) is executed, if no, the data-processing device is in the initial state; b. the data-processing device discriminates whether the store device is stored therein environmental parameters by executing a Basic Input Output System; if yes, the method skips directly to executing of a step (d.), if no, the step (c.) is executed; c. activating the operating system, and then skipping to a step (e.); 2. a step of monitoring and controlling the main power source: d. the environmental parameters of the store device are stored in the data-processing device, in order that the data-processing device restores the operation environment of the operating system before the main power source is interrupted; e. the data-processing device executes the operating system; f. when the main power source is interrupted, a spare power source is immediately used, then the data-processing device executes a waiting step, if the main power source has not yet been resumed the normal state at the end of the waiting step, the method skips to a step (g.), if the main power source is resumed during executing the waiting step, the step (e.) is executed; g. the environmental parameters in the operation environment of the present operating system of the data-processing device are stored in the store device; and h. the data-processing device is rebooted to execute the electric-power restoring step of the main power source.

Moreover, the present invention provides a data-processing device with a state-restoring function, it comprises: a spare power source for the data-processing device used in case the main power source is interrupted; a store device to store environmental parameters; program codes to monitor and control interruption of the main power source, the codes are used to store the environmental parameters in the operation environment of the present operating system during execution of the data-processing device when the main power source is interrupted, and to reboot the data-processing device; program codes for discriminating whether the main power source is normally to supply electric power, the codes are used to store the environmental parameters of the store device in the data-processing device when the main power source is resume to supply electric power and the data-processing device reboots, in order that the data-processing device restores the operation environment of the operating system before the main power source is interrupted.

The present invention will be apparent in its objects, features and advantages after reading the detailed description of the preferred embodiment thereof in reference to the accompanying drawings.

### BRIEF DESCRIPTION OF THE DRAWINGS

FIG. 1 shows a process chart of a data processing method with a state-restoring function provided by a preferred embodiment of the present invention; and

FIG. 2 is a block diagram of a data-processing device adapted for using the method of the present invention.

### DETAILED DESCRIPTION OF THE INVENTION

The method of the present invention can allow a data-processing device 200 to store environmental parameters 213 in corresponding to the present operation state in the store device 203 in an extremely short time after a main power supply 300 (such as a city power supply) is gone, and to read again the antecedent environmental parameters 213 when the main power supply 300 comes back, to thereby restore the state before the main power source is interrupted. An embodiment of the data-processing device 200 for practicing the method of the present invention can be a server or a personal computer (PC). The store device 203 used for the method of the present invention can be a hard disk etc.

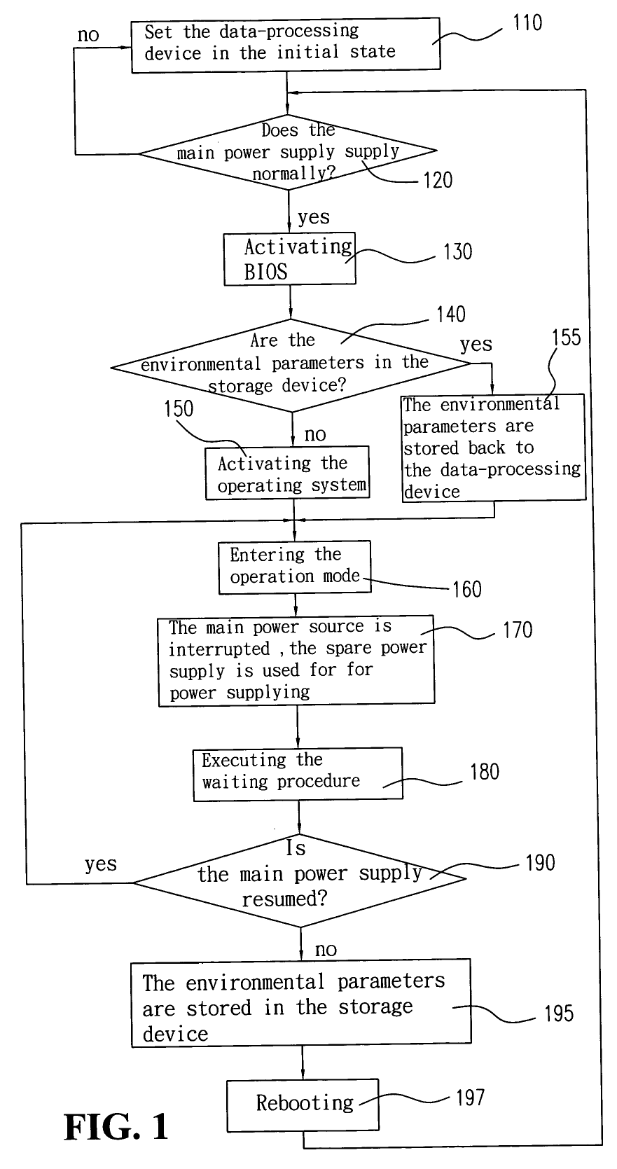

Referring to FIG. 1 being a process chart of the data processing method with a state-restoring function provided as a preferred embodiment of the present invention, before booting, when the data-processing device 200 is in a state having no any electric power supplying, this state of the data-processing device 200 is called in the present invention as an initial state. Wherein, a step 110 represents that the data-processing device 200 has now no supplying of a main power source of any form such as a city power supply or a battery equivalent to the city power supply. In a step 120 of which the time for execution is at the rebooting time of the data-processing device 200 or at the time when the main power supply 300 supplies power, the data-processing device 200 discriminates whether the main power supply 300 is normal; if the main power supply 300 does not normally supplies power, the data-processing device 200 enters the step 120 only when the it is rebooted through a step 197, at this time, electric power is still supplied by a spare power supply 201, and the data-processing device 200 is placed to the initial state of the step 110. If the data-processing device 200 discriminates that the main power supply 300 normally supplies power, the data-processing device 200 enters a step 130. The step 130 represents that the main power supply 300 normally supplies power, and the data-processing device 200 activates the Basic Input Output System (BIOS) 205. A step 140 represents that in completion of execution of the BIOS 205, the data-processing device 200 discriminates whether the store device 203 is stored with the environmental parameters 213 before power interruption; if yes, the method skips to a step 155, if no, a step 150 is executed. In the step 150, the data-processing device 200 activates an operating system (OS) 207, such as a Microsoft window operating system; after activating of the operating system 207, the method enters a step 160. The step 155 reads out the environmental parameters 213 from the store device 203 and then stores back to the data-processing device 200. In the step 160, the data-processing device 200 executes the operating system 207; now the data-processing device 200 executes all kinds of applications on the platform of the operating system 207, the data-processing device 200 in the step 160 enters an operation mode or a runtime mode.

In a step 170, when the maim power source is interrupted, the data-processing device 200 immediately takes the spare power supply 201 for power supplying; the spare power supply 201 for instance is a dry battery, a lithium battery or a nickelous hydride battery etc. When the data-processing device 200 uses the spare power supply 201 for power supplying, the data-processing device 200 will executes a waiting step 180, the waiting step 180 leaves the data-processing device 200 idle for such as 15 seconds to wait, in order to assure whether power supplying of the main power supply 300 is really interrupted. When the data-processing device 200 executes the waiting step 180, it will continuously discriminates whether power supplying of the main power supply 300 has been resumed, this is a step 190. If the main power supply 300 is resumed in execution of the waiting procedure, the data-processing device 200 goes back to the operating mode of the step 160; if the main power supply 300 has not yet been resumed at the end of the waiting procedure, a step 195 is executed. It needs to be noted that, setting of the waiting time can be decided according to the capacity of the spare power supply 201, as for the kind of spare power supply 201 stated above, the data-processing device 200 is definitely able to run 15 to 20 seconds after interruption of the main power supply 300.

If the main power supply 300 has not yet been resumed at the end of the waiting procedure, the data-processing device 200 executes the step 195 to store the present environmental parameters 213 in the store device 203, the environmental parameters 213 will faithfully reflect the operation environment of the data-processing device 200 presently, such as, which files are opened or which application programs are being executed. After completion of storing of the environmental parameters 213, the data-processing device 200 executes a step 197 to reboot the data-processing device 200 and go back to execute the step 120.

By the above disclosure of the present invention, the principle of the method can be divided into a step of the electric power restoring of the main power source and a step of monitoring and controlling interruption of the main power source. The step of the electric power restoring of the main power source comprises the steps 110, 120, 130, 140 and 155 etc., while the step of monitoring and controlling interruption of the main power source comprises the steps 160, 170, 180, 190 195 and 197 etc.

By virtue that the present invention executes rebooting rather than shutting down to totally cut the entire electric power after storing of the environmental parameters 213, if the main power supply 300 is resumed exactly when the data-processing device 200 executes the rebooting procedure, the step 120 will discriminate that the main power supply 300 supplies power and booting procedure is automatically performed, the data-processing device 200 is not forcedly shut down.

On the other hand, after rebooting, if the main power supply 300 has not yet been resumed, the data-processing device 200 will be in the initial state; when the main power supply 300 is resumed, the data-processing device 200 will automatically enters the booting process without manual power activating by an operator, thereby, the data-processing device 200 will boot in the shortest time when the electric power is restored, its time efficiency is better than that before.

As stated above, when the interrupted main power supply 300 does not be resumed at the end of the waiting procedure, the data-processing device 200 will store the present environmental parameters 213 in the store device 203. In such situation, after the interrupted main power supply 300 is resumed, and when the booting procedure goes to the step 140, it is discriminated that the present environmental parameters 213 are stored in the store device 203. Now the booting process will execute the step 155 rather than the step 150, and restore the operation environment of the data-processing device 200 utilizing the present environmental parameters 213 to restore the state before interruption of electric power, this is much more convenient than the conventional ways.

More importantly, using the state-restoring function of the present invention, the complicated shutdown procedure can be simplified; it needs only to code the present invention in the BIOS 205 by a firmware embodying means, or by using application programs in the operating system 207 for embodying, the booting procedure can thus be largely simplified. For example, in the working field such as a large office or computer class room having many computers, if each computer can support the data processing method with a state-restoring function of the present invention, when users go away, all the computers can be shut down just by cutting off the general power source. And all the computers also can be booted by turning on the general power source, and then every individual computer can automatically restore its state before shutting down; this is very convenient. By all means, the suitable scope of application of the present invention is not limited to such case of having many computers; a computer used at home can also be as convenient as this. If a computer of a user supports such a data processing method, it needs only that the computer is provided therein with a spare power source (such as a dry battery), so that when the main power source restores, the computer can automatically boot to enter the state before interruption of electric power of the operating system, this is excellently convenient.

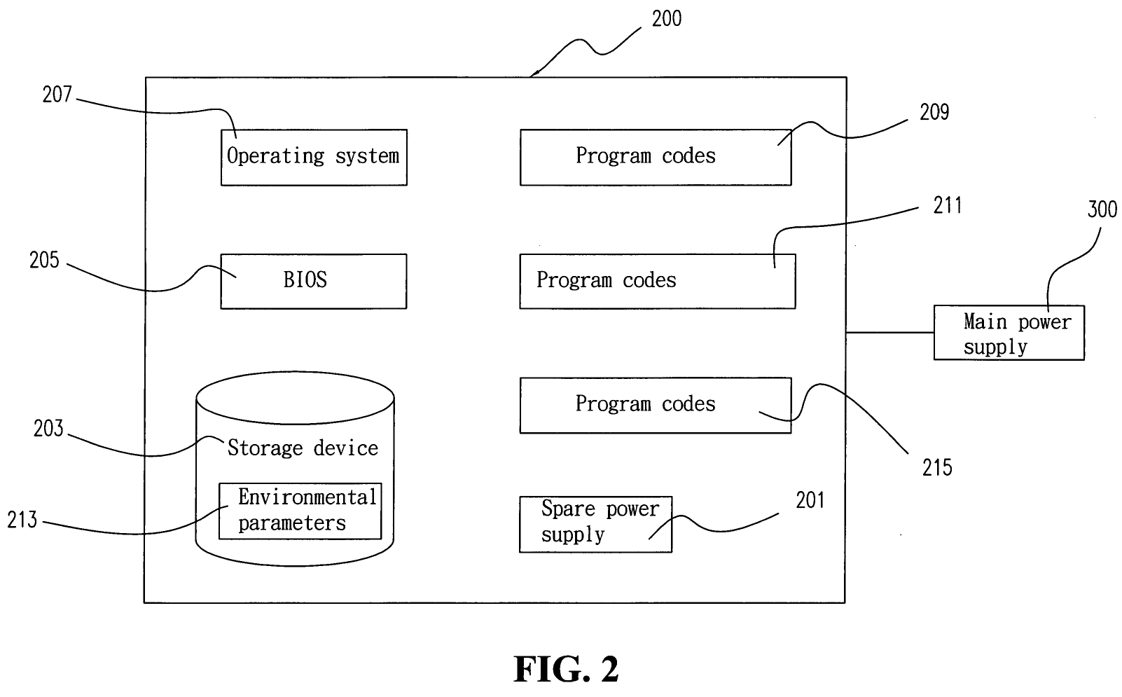

FIG. 2 shows a block diagram of a data-processing device adapted for using the method of the present invention, the data-processing device 200 with a state-restoring function of the present invention includes a spare power supply 201 used when the main power supply 300 of the data-processing device 200 is interrupted; the store device 203 stores the environmental parameters 213; program codes 211 monitoring and controlling interruption of the main power supply 201 are used when power supplying of the main power supply 300 is interrupted to store the environmental parameters 213 of the operating environment of the operating system 207 that the store device 203 executes then, and to reboot the data-processing device 200.

The program codes 209 are used to store the environmental parameters 213 of the store device 203 in the data-processing device 200 when the main power supply 300 is resumed and the data-processing device 200 reboots, in order that the data-processing device 200 restore the operation environment of the operating system 207 before the main power supply 300 is interrupted. And more, the data-processing device 200 further includes program codes 215 used to make the data-processing device 200 idle and wait for a period of time, in order to be aware of whether power supplying of the main power supply 300 is interrupted.

Setting up of the BIOS 205 of the data-processing device 200 of the present invention can be done to set the parameter POWER LOSE as automatic booting, in this way, the data-processing device 200 can automatically restore the preceding operation environment when the main power supply 300 supplies power; otherwise, the supplying line of electric power of the data-processing device 200 can be slightly adapted for rendering the data-processing device 200 to automatically activate the power source for booting when the main power supply 300 supplies power. Thereby, the present invention can have a larger effect to automatically activate the electric power-source mechanism in cooperating with the city power supply.

The data processing method with a state-restoring function of the present invention disclosed at least has the following advantages:

1. It can avoid the situation that: the system has restored its execution of the shutdown process, but the computer still shuts down definitely;

2. After resumption of the main power source, the computer immediately shuts down; its time efficiency is good;

3. The computer automatically restores its operation state after booting; it is more convenient than before;

4. The computer needs only to be provided with normal batteries to support the data processing method of the present invention, this can save large expenditure for providing UPS, the economic efficiency of it is outstanding; and

5. Many computers can be shut down simultaneously by shutting down a general power source, and all the computers also can be booted by turning on the general power source to automatically restore their states before shutting down; this not only can effectively avoid data loss induced by abrupt interruption of the main power source, but also can avoid the trouble of activating and shutting down the computers one by one to simplify the processes of booting and shutting down, this is excellent in convenience.

In conclusion, although the present invention has been disclosed above with a preferred embodiment, it is only for illustrating the present invention, and not for giving any limitation to the scope of the present invention. It will be apparent to those skilled in this art that various modifications or changes made to the present invention without departing from the spirit and scope of this invention shall fall within the scope of protection of the appended claims.

What is claimed is:

1. A data processing method with a state-restoring function, said method suits a data-processing device having a spare power source; wherein said data-processing device is mounted with a store device; when said data-processing device is in a state of shutdown, it is in an initial state; said method comprises following steps:
1) an electric-power restoring step of a main power source, said step further includes steps below:
a. said data-processing device discriminates whether power supplying of said main power source is in a normal state; if yes, a following step (step b.) is executed, if no, said data-processing device is in said initial state;
b. said data-processing device discriminates whether said store device is stored therein environmental parameters by executing a Basic Input Output System; if yes, said method skips directly to executing of a following step (step d.), if no, a following step (step c.) is executed;
c. this step activates an operating system, and then skips to a following step (step e.);
2) a step of monitoring and controlling said main power source, said step further includes steps below:
d. said environmental parameters of said store device are stored in said data-processing device, in order that said data-processing device restores said operation environment of said operating system before said main power source is interrupted;
e. said data-processing device executes said operating system;
f. when said main power source is interrupted, said spare power source is immediately used, then said data-processing device executes a waiting step, if said main power source has not yet been resumed at the end of said waiting step, said method skips to a following step (step g.), if said main power source is resumed during executing said waiting step, said step (e.) is executed;
g. said environmental parameters in said operation environment of said operating system at present of said data-processing device are stored in said store device; and
h. said data-processing device is rebooted to execute an electric-power restoring step of said main power source.

2. The method as in claim 1, wherein said data-processing device is a server.

3. The method as in claim 1, wherein said data-processing device is a personal computer.

4. The method as in claim 1, wherein said waiting step leaves said data-processing device idle to wait a period of time.

5. The method as in claim 4, wherein setting of said waiting time is decided according to capacity of said spare power source.

6. The method as in claim 1, wherein said store device is a hard disk.

7. A data-processing device with a state-restoring function, said data-processing device comprises:
a spare power supply for said data-processing device used in case a main power source is interrupted;
a store device to store environmental parameters;
first program codes to monitor and control interruption of said main power source, said first codes are used to store said environmental parameters in an operation environment of an operating system at present during execution of said data-processing device when said main power source is interrupted, and to reboot said data-processing device;
second program codes for discriminating whether said main power source is normally to supply electric power, said second codes are used to store said environmental parameters of said store device in said data-processing device when said main power source is resumed to supply electric power and said data-processing device reboots, in order that said data-processing device restores an operation environment of an operating system before said main power source is interrupted.

8. The data-processing device as in claim 7, wherein said data-processing device is a server.

9. The data-processing device as in claim 7, wherein said data-processing device is a personal computer.

10. The data-processing device as in claim 7, wherein said data-processing device further comprises third program codes used to leave said data-processing device idle to wait a period of time.

11. The data-processing device as in claim 10, wherein setting of said waiting time is decided according to capacity of said spare power source.

12. The data-processing device as in claim 7, wherein said store device is a hard disk.
